(19) United States
(12) Patent Application Publication
(10) Pub. No.: US 2024/0184049 A1
(43) Pub. Date: Jun. 6, 2024

(54) OPTICAL PATHS FOR LASER ENERGY SOURCES IN ADDITIVE MANUFACTURING SYSTEMS

(71) Applicant: VulcanForms Inc., Burlington, MA (US)

(72) Inventor: Peter Colin Reeves-Hall, Whitinsville, MA (US)

(73) Assignee: VulcanForms Inc., Burlington, MA (US)

(21) Appl. No.: 18/524,543

(22) Filed: Nov. 30, 2023

Related U.S. Application Data
(60) Provisional application No. 63/429,242, filed on Dec. 1, 2022.

(51) Int. Cl. G02B 6/26; B22F 10/28; B22F 12/41; B23K 26/342; B28B 1/00; B29C 64/153; B29C 64/268; B33Y 10/00; B33Y 30/00; G02B 6/02

(52) U.S. Cl. CPC G02B 6/262; B22F 10/28; B22F 12/41; B23K 26/342; B28B 1/001; B29C 64/153; B29C 64/268; B33Y 10/00; B33Y 30/00; G02B 6/02042

(57) ABSTRACT

Additive manufacturing systems and their methods of use are disclosed. According to some embodiments, a delivery portion of small optical fiber is optically coupled to a large optical fiber by an adiabatic fiber taper. In some instances, an additional reducing taper may be included between the small optical fiber and the adiabatic fiber taper. Increasing the transverse dimension and therefore the cross sectional area of the optical fiber path may reduce the power and/or energy density near the termination of the laser path. Decreased power and/or energy density may provide increased life, reliability, and contamination tolerance of the optic fibers, termination surfaces, and other components located along an optical path connected to a laser energy source.

### RELATED APPLICATION

This application claims priority under 35 U.S.C. § 119(e) to U.S. Provisional Application No. 63/429,242, filed Dec. 1, 2022, the content of which is incorporated by reference in its entirety for all purposes.

### FIELD

Disclosed embodiments are generally related to optical paths for laser energy sources in additive manufacturing systems.

### BACKGROUND

Additive manufacturing systems employ various techniques to create three-dimensional objects from two-dimensional layers. For instances, in some additive manufacturing systems, after a layer of precursor material is deposited onto a build surface, a portion of the layer may be fused through exposure to one or more energy sources to create a desired two-dimensional geometry of solidified material within the layer. Next, the build surface may be indexed, and another layer of precursor material may be deposited prior to fusing one or more portions of this new layer. This process may be repeated layer-by-layer to fuse many two-dimensional layers into a three-dimensional object.

### SUMMARY

According to some aspects, an additive manufacturing system, comprises a laser energy source, an optics assembly configured to direct laser energy from the laser energy source to form a laser energy pixel on the build surface, a first optical fiber optically coupled to the laser energy source and a second optical fiber optically coupled to the optics assembly. A transverse dimension of the first optical fiber is less than a transverse dimension of the second optical fiber. An adiabatic fiber taper optically couples the first optical fiber to the second optical fiber. The adiabatic fiber taper includes an upstream end portion optically coupled to the first optical fiber and a downstream end portion optically coupled to the second optical fiber, and wherein a transverse dimension of the upstream end portion is less than a transverse dimension of the downstream end portion.

According to other aspects, an additive manufacturing method is provided. The method comprises emitting laser energy from a laser energy source into a first optical fiber, and expanding the emitted laser energy in an adiabatic fiber taper from the first optical fiber to a second optical fiber. A transverse dimension of the first optical fiber is less than a transverse dimension of the second optical fiber. The method further comprises directing the laser energy from the second optical fiber onto a build surface of an additive manufacturing system.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

Other advantages and novel features of the present disclosure will become apparent from the following detailed description of various non-limiting embodiments of the disclosure when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 shows a schematic representation of an additive manufacturing system according to some embodiments;

FIG. 2 shows the optical paths present in an additive manufacturing system according to some embodiments;

FIG. 3 shows an additive manufacturing system according to some embodiments;

FIG. 4 shows a laser optical path according to some embodiments;

FIG. 5 shows a laser optical path according to some embodiments;

FIG. 6A shows a schematic of light propagation within one embodiment of an optical path;

FIG. 6B shows another schematic of light propagation within one embodiment of an optical path;

FIG. 7 shows one embodiment of an optical path including cladding mode strippers; and

FIG. 8 shows a laser optical path including an endcap according to some embodiments.

### DETAILED DESCRIPTION

Energy sources used in additive manufacturing processes may include laser energy sources. An optical path may be utilized to convey laser energy, such as a laser beam, from a laser energy source to a print head or optics assembly from which the laser energy may be applied to the build surface. An optical path may include a fiber optic laser path. In some additive manufacturing processes a plurality of laser energy sources may be used. High laser powers may be used in additive manufacturing applications. Increasing the power through a given optical path may tend to increase rates of failure of the optical path. Power may be quantified as peak power density (power per unit area W/mm²) for continuous wave (CW) operation and/or energy per unit area (J/mm²) for pulsed operation. The greater power/energy density the lower the reliability of a fiber optic termination due to failure modes caused by breakdown of the material at the air interface and/or contaminates that are strong absorbers of the laser energy causing localized heating and thermal run-away during the lifetime of the termination.

The Inventors have recognized that increasing the fiber core transverse dimension to reduce end face intensity is desirable. However, limiting the number of higher order modes that the fiber may support may involve using very low numerical aperture (NA) fibers which may suffer from higher bending losses. Without wishing to be bound by theory, transferring the energy from the lowest mode (LP01 mode) to higher order modes may cause transfer of energy from the core of an optical fiber to the cladding. High bending losses may also render the use of single large optical fibers impractical in most applications where fibers need to be routed or otherwise bent during operation.

In view of the above, the Inventors have recognized and appreciated the benefits associated with methods and systems including a large optical fiber that is positioned downstream from and optically coupled to a smaller upstream optical fiber that is optically coupled to a laser energy source. In other words, a first optical fiber may have a transverse dimension that is less than a transverse dimension of a second optical fiber that is positioned downstream from and optically coupled to the first optical fiber. This combined optical path may connect the laser energy source with an optics assembly that directs the laser energy onto a build surface of an additive manufacturing system. To help reduce, or substantially eliminate, the occurrence of multi-mode transmission within the large downstream fiber, it may be desirable to include an adiabatic fiber taper that optically couples the two optical fibers together. An adiabatic fiber taper may be configured to receive laser energy in a lowest order mode at an upstream end portion and maintain laser energy in a lowest order mode at the downstream end portion. A transverse dimension of the upstream end portion of the adiabatic fiber taper may substantially match a transverse dimension of a core of the upstream smaller optical fiber that the adiabatic fiber taper is connected to and a transverse dimension of the downstream end portion of the adiabatic fiber taper may substantially match a transverse dimension of a core of the downstream larger optical fiber the adiabatic fiber taper is connected to. In some embodiments, an upstream portion of the large optical fiber may be adiabatically tapered to match a size of the core of the small upstream optical fiber.

While adiabatic fiber tapers may not represent the only method of joining optical fibers of different transverse dimensions, there may be distinct advantages to their use. For example, a simple cleaved and polished junction is possible, but would exhibit an increased likelihood of mode disturbance and energy loss. A simple splice, that is a splice formed by abutting one cleaved surface to another cleaved surface also does not lend itself to mode matching. Specifically, a large portion of incoming lowest mode (i.e., LP01) laser energy may be expected to transfer to higher order modes and/or pass into the cladding. Without wishing to be bound by theory, tapers less abrupt than a cleaved junction but less gradual than an adiabatic fiber taper are possible but may also result in greater distortion and loss than would be with present adiabatic tapers.

As noted above, typical single fiber terminations with just an end-face may exhibit higher failure rates due to heating and back reflections associated with higher power densities. In contrast, the use of large optical fibers in the disclosed methods and systems may reduce an areal power density (i.e., power per unit area of a cross section taken in a plane perpendicular to a longitudinal direction of an optical fiber) of the optical fibers at this emission end which may provide multiple potential benefits. Reducing the areal energy density at the interface may reduce the potential and/or severity of heating at this interface which may result in a more reliable optical system. The disclosed methods and systems may also result in reduced transmission of multi-mode optical signals within an optical fiber. Of course, other benefits different than those noted above may also be provided in some embodiments as the disclosure is not limited in this fashion.

In the above described embodiment, only two optical fibers and a single adiabatic fiber taper are described. However, embodiments, in which a series of optical fibers with sequentially increasing sizes in the downstream direction and a corresponding number of adiabatic fiber tapers positioned between these optical fibers are used are also contemplated. This may permit, for example, several successive increases in fiber diameter along a length of the optical path. For example, the optical path may include a long small optical fiber that is optically coupled to an intermediate size fiber which may be coupled to a large optical fiber with an adiabatic fiber taper disposed between each transition in fiber size. Thus, the transverse dimension of the optical path may increase in the direction of primary light travel. Accordingly, it should be understood that the disclosure is not limited in the number of size changes and adiabatic fiber tapers that may be included along a single optical path.

In some embodiments, an optical path embodying the disclosed constructions may exhibit a M² value approaching 1.07. M² also termed M² factor, beam quality factor, or beam propagation factor, is a measure of the ability of a beam to be focused. An “ideal” beam would be focus limited only by diffraction at the scale of the wavelength of its radiation and would be said to have an M² of unity. Real, non-ideal beams will have an M² value greater than 1, becoming farther from ideal as M² increases. According to some embodiments, M² may be <2, according to other embodiments, M² may be within the range 1.07 to 1.5. Of course, systems and optical paths exhibiting ranges both greater and less than those noted above are also contemplated as the disclosure is not so limited.

In some embodiments, an optical fiber may be single mode fiber that is configured to support the fundamental or lowest order mode (i.e., LP01) of a single mode waveguide. In some embodiments an optical fiber may be “near single mode” and the next few higher order modes may be supported depending on core size and NA. For instance, modes such as LP11 the next higher mode from LP01. The lowest mode (LP01) is most desirable to give M² near unity, in some embodiments approaching M²=1.07. Very large core fibers are typically multi-mode and are therefore less desirable for energy transmission despite potential advantages associated with lower power/energy density at the termination. Within an optical path, the presence of higher order modes and loss of energy to cladding, such as from bending losses, would decrease beam quality, potentially increasing the M² value to much greater than 1.1 according to some embodiments.

In the various embodiments disclosed herein, the small optical fiber, which may also be referred to herein as a delivery fiber, may be any suitable single mode fiber. For example, the small optical fiber may be a photonic crystal fiber, a double clad fiber, a triple clad fiber, and/or any other appropriate optical fiber and/or type of cladding. The delivery fiber may be a small optical fiber that includes a core with a transverse dimension of less than or equal to 10 μm, 15 μm, 20 μm, 25 μm and/or any other appropriate dimension. The transverse dimension of the core of the small optical fiber may also be greater than or equal to 10 μm, 15 μm, 20 μm, and/or any other appropriate dimension. The outer transverse dimension of the small optical fiber may be greater than or equal to 100 μm, 125 μm, 150 μm, and/or any other appropriate dimension. A fiber may have an outer transverse dimension of less than or equal to 125 μm, 150 μm, 200 μm, 250 μm and/or any other appropriate dimension. Combinations of the foregoing ranges are contemplated including, for example, a small optical fiber with a core having a transverse dimension that is between or equal to 10 μm and 25 μm. The small optical fiber may also have an outer transverse dimension that is between or equal to 125 μm and 250 μm. Of course, ranges greater than and less than those noted above are also contemplated as the disclosure is not so limited.

As noted above a large optical fiber may be connected to a downstream portion of a delivery fiber proximate to the optics assembly of an additive manufacturing system and distal to the laser energy source. The transverse dimension of the large optical fiber may be described relative to be the transverse dimension of the constant dimension portion of the large optical fiber disposed downstream from the adiabatic fiber taper, that is in a direction distal to the laser energy source. This applies to both core transverse dimension and outer transverse dimension. The core dimension of the large optical fiber may be greater than or equal to 100 μm, 125 μm, 250 μm, and/or any other appropriate dimension. The core transverse dimension of the large optical fiber may also be less than or equal to 500 μm, 250 μm, 125 μm, and/or any other appropriate dimension. Combinations of foregoing are contemplated including, for example, a core dimension of the large optical fiber that is between or equal to 100 μm and 500 μm. The outer transverse dimension of the large optical fiber may also be less than or equal to 1000 μm, 500 μm, 250 μm, and/or any other appropriate dimension. The outer transverse dimension of the large optical fiber may also be greater than or equal to 125 μm, 250 μm, 500 μm, 750 μm, and/or any other appropriate dimension. Combinations of the foregoing are contemplated including an outer transverse dimension of a large optical fiber that is between or equal to 125 μm and 1000 μm. Additionally, a transverse dimension of the core of the large optical fiber may be between or equal to 100 μm and 500 μm. Of course, ranges greater than and less than those noted above are also contemplated as the disclosure is not so limited.

As noted above, large optical fibers may exhibit high bending losses. Therefore, in some embodiments, it may be desirable to limit a length of the downstream large optical fiber. For example, a large optical fiber may have a length that is between or equal to 10-100 mm. The relatively short 10-100 mm portion of the large optical fiber may be supported along at least a portion of its length, and in some embodiments, along its entire length, to maintain a substantially straight optical path in the large optical fiber and thereby mitigate the effect of bending losses therein. According to some embodiments, a ratio of the large optical fiber length to the transverse dimension of the large optical fiber is less than or equal to 10,000.

As noted above, reflections off a fiber-air interface and/or back reflections from the termination or other downstream optical elements as well as from the additive manufacturing process material interactions may result in laser energy traveling backwards along an optical path connected to a laser energy source. This backwards traveling laser energy is typically multi-mode, and thus may escape into the cladding. Some laser energy, including multi-mode light may also enter the cladding in the forward direction as well. Thus, it may be desirable to remove the energy associated with this light, for instance for thermal reasons. Thus, one or more cladding mode strippers (CMS) may be operatively coupled to one or more of the large optical fiber, the small optical fiber, and/or the adiabatic fiber taper to remove cladding laser energy in both the forwards and backwards directions in the various embodiments described herein.

The disclosed optical fibers, systems, and methods may be used with any appropriate additive manufacturing process and/or system where high power laser energy is delivered to one or more portions of a build surface including a precursor material that can be melted, sintered, cross-linked, reacted, and/or otherwise fused to form a solid weld on a build surface. For example, in some embodiments, powder bed fusion additive manufacturing processes and/or systems may implement the disclosed methods and systems. Other appropriate types of additive manufacturing systems may also include, but are not limited to stereolithography (SLA), other additive manufacturing processes using a plurality of laser energy sources, and/or other processes where a precursor material interacts with high power laser energy. Appropriate types of precursor materials that may be used with the disclosed methods and systems may include, but are not limited to, a polymer (cross-linked or fused), a metal (fused), a ceramic (fused or vitrified), and/or appropriate composites including at least one of the forgoing. Additionally, while a system may include a single optical path linking a laser energy source to a desired optics assembly or other output, embodiments in which multiple optical paths including multiple sets of large and small optical fibers, as disclosed herein, that are associated with a plurality of separate laser energy sources are also contemplated. It is also noted that while the disclosed methods and systems are primarily directed to additive manufacturing processes and systems, in some embodiments, lasers emitting into working environments that may include spatter, smoke, or other contaminants may similarly benefit from lower power densities at the point of emission from the optic fibers, and thus, may include similar optical arrangements connected to an associated laser energy source. Examples include laser welding equipment and medical lasers. Thus, the currently disclosed systems should not be limited to any specific application.

In some embodiments, one or more components (e.g., endcaps, optical fibers, one or more portions of a stray light baffle, one or more portion of the alignment fixtures, etc.) of an additive manufacturing system may be at least partially (e.g., completely) coated with an antireflective coating or other desired coating. The antireflective coating may, in some embodiments, reduce the reflection of laser energy from the surfaces on which they may be applied. The antireflective coating may be applied using sputtering, ion beam sputtering, ion beam magnetron sputtering, evaporative methods, and/or any other suitable method to apply a coating to a transparent base material. This may advantageously increase the power area density of the transmitted laser energy, while reducing undesirable reflection of laser energy towards the laser energy source. In some embodiments, antireflective coatings may include abrasive treatment of the desired surface to scatter or otherwise limit the amount of laser energy flowing in an undesirable direction. Any suitable coating and/or treatment of the various optical components described herein may be employed to limit stray light within the optical system.

In some embodiments, incident laser spots on a build surface may be arranged in a line with a long dimension and a short dimension, or in an array. In either case, according to some aspects, a line, or array, of incident laser energy consists of multiple individual laser energy pixels arranged adjacent to each other that can have their respective power levels individually controlled. Each laser energy pixel may be turned on or turned off independently and the power of each pixel can be independently controlled. The resulting pixel-based line or array may then be scanned across a build surface to form a desired pattern thereon by controlling the individual pixels during translation of the optics assembly. Laser energy may be transmitted from the laser energy source to the optics head by one or a plurality of optical paths such as those disclosed herein. In some embodiments, each laser pixel may have its own optical path.

Depending on the particular embodiment, an additive manufacturing system according to the current disclosure may include any suitable number of laser energy sources. For example, in some embodiments, the number of laser energy sources may be at least 5, at least 10, at least 50, at least 100, at least 500, at least 1,000, at least 1,500, or more. In some embodiments, the number of laser energy sources may be less than 2,000, less than 1,500, less than 1,000, less than 500, less than 100, less than 50, or less than 10. Additionally, combinations of the above-noted ranges may be suitable. Ranges both greater and less than those noted above are also contemplated as the disclosure is not so limited.

Additionally, in some embodiments, a power output of a laser energy source (e.g., a laser energy source of a plurality of laser energy sources) may be between about 50 W and about 2,000 W (2 kW). For example, the power output for each laser energy source may be between about 100 W and about 1.5 kW, and/or between about 500 W and about 1 kW. Moreover, a total power output of the plurality of laser energy sources may be between about 500 W (0.5 kW) and about 4,000 kW. For example, the total power output may be between about 1 kW and about 2,000 kW, and/or between about 100 kW and about 1,000 kW. Ranges both greater and less than those noted above are also contemplated as the disclosure is not so limited.

Depending on the embodiment, an array of laser energy pixels (e.g., a line array or a two dimensional array) may have a uniform power density along one or more axes of the array including, for example, along the length dimension (i.e. the longer dimension) of a line array. In other instances, an array can have a non-uniform power density along either of the axes of the array by setting different power output levels for each pixel's associated laser energy source. Moreover, individual pixels on the exterior portions of the array can be selectively turned off or on to produce an array with a shorter length and/or width. In some embodiments, the power levels of the various pixels in an array of laser energy may be independently controlled throughout an additive manufacturing process. For example, the various pixels may be selectively turned off, on, or operated at an intermediate power level to provide a desired power density within different portions of the array.

Generally, laser energy produced by a laser energy source has a power area density. In some embodiments, the power area density of the laser energy transmitted through an optical fiber is greater than or equal to 0.1 W/μm², greater than or equal to 0.2 W/μm², greater than or equal to 0.5 W/μm², greater than or equal to 1 W/μm², greater than or equal to 1.5 W/μm², greater than or equal to 2 W/μm², or greater. In some embodiments, the power area density of the laser energy transmitted through the optical fiber is less than or equal to 3 W/μm², less than or equal to 2 W/μm², less than or equal to 1.5 W/μm², less than or equal to 1 W/μm², less than or equal to 0.5 W/μm², less than or equal to 0.2 W/μm², or less. Combinations of these ranges are possible. For example, in some embodiments, the power area density of the laser energy transmitted through the optical fiber is greater than or equal to 0.1 W/μm² and less than or equal to 3 W/μm².

Depending on the application, output of the optics assembly may be scanned across a build surface of an additive manufacturing system in any appropriate fashion. For example, in one embodiment, one or more galvo scanners may be associated with one or more laser energy sources to scan the resulting one or more laser pixels across the build surface. Alternatively, in other embodiments, an optics assembly may include an optics head that is associated with one or more appropriate actuators configured to translate the optics head in a direction parallel to a plane of the build surface to scan the one or more laser pixels across the build surface. In either case, it should be understood that the disclosed systems and methods are not limited to any particular construction for scanning the laser energy across a build surface of the additive manufacturing system.

For the sake of clarity, transmission of laser energy through an optical fiber is described generically throughout. However, with respect to various parameters such as transverse cross-sectional area, transverse dimension, transmission area, power area density, and/or any other appropriate parameters related to a portion of an optical fiber that the laser energy is transmitted through, it should be understood that these parameters refer to either a parameter related to a bare optical fiber and/or a portion of an optical fiber that the laser energy is actively transmitted through such as an optical fiber core, or a secondary optical laser energy transmitting cladding surrounding the core. In contrast, any surrounding cladding, coatings, or other materials that do not actively transmit the laser energy may not be included in the disclosed ranges.

Optical paths may include optical fibers of various size cross sections. The various embodiments described herein may refer to large optical fibers and small optical fibers. Small fibers, small core fibers, small diameter optical fibers, and other similar terms may refer to an optical fiber with a core that has a transverse dimension that is smaller than a transverse dimension of a core of large optical fibers, large core fibers, large diameter optical fibers, or other similar terms to refer to the larger optical fiber located downstream from and optically coupled to the smaller optical fiber. It should be appreciated that the various optical fibers described herein may exhibit circular fiber cross sections, though non-circular fiber cross sections are also contemplated. Fiber core size, core dimension, or core transverse dimension may be used to describe the cross sectional dimension and may apply to round fibers (as a diameter) or to fibers of any other shape. Fiber transverse dimensions may refer to a nominal fiber dimension, and in some embodiments may refer to an average dimension. For example, an average transverse dimension (e.g., diameter) along a length of the optical fiber.

It will be appreciated that any embodiments of the systems, components, methods, and/or programs disclosed herein, or any portion(s) thereof, may be used to form any part suitable for production using additive manufacturing. For example, a method for additively manufacturing one or more parts may, in addition to any other method steps disclosed herein, include the steps of selectively fusing one or more portions of a plurality of layers of precursor material deposited onto the build surface to form the one or more parts. This may be performed in a sequential manner where each layer of precursor material is deposited on the build surface and selected portions of the upper most layer of precursor material is fused to form the individual layers of the one or more parts. This process may be continued until the one or more parts are fully formed.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

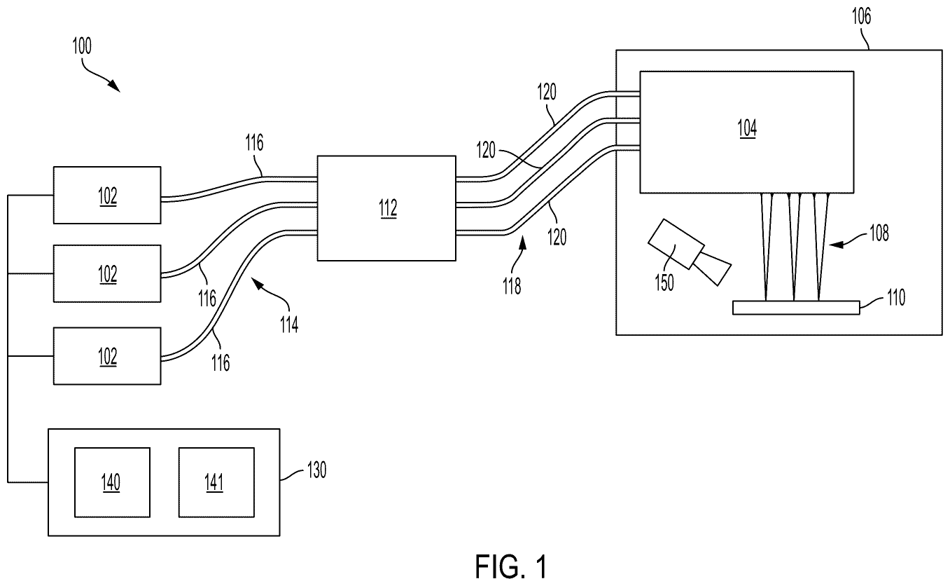

FIG. 1 shows, according to some embodiments, a schematic representation of an additive manufacturing system 100, including a plurality of laser energy sources 102 that deliver laser energy to an optics assembly 104 positioned within a machine enclosure 106. For example, the machine enclosure may define a build volume in which an additive manufacturing process may be carried out. In particular, the optics assembly may direct laser energy 108 towards a build surface 110 positioned within the machine enclosure to selectively fuse powdered material on the build surface. As described in more detail below, the optics assembly 104 may include a plurality of optics defining an optical path within the optics assembly that may transform, shape, and/or direct laser energy within the optics assembly such that the laser energy is directed onto the build surface as an array of laser energy pixels. In some embodiments, the optics assembly may be movable within machine enclosure 106 to scan laser energy 108 across build surface 110 during a manufacturing process. For example, the optics assembly may be associated with appropriate actuators, rails, motors, and/or any other appropriate structure capable of optics assembly relative to the surface. Alternatively, embodiments in which the optics assembly includes galvomirrors or other appropriate components that are configured to scan the laser energy 108 across the build surface while the optics assembly is held stationary relative to the build surface are also contemplated.

In some embodiments, the additive manufacturing system 100 further includes one or more optical fiber connectors 112 positioned between the laser energy sources 102 and the optics assembly 104. As illustrated, a first plurality of optical fibers 114 may extend between the plurality of laser energy sources 102 and the optical fiber connector 112. In particular, each laser energy source 102 may be coupled to the optical fiber connector 112 via a respective optical fiber 116 of the first plurality of optical fibers 114. Similarly, a second plurality of optical fibers 118 extends between the optical fiber connector 112 and the optics assembly 104. Each optical fiber 116 of the first plurality of optical fibers 114 is coupled to a corresponding optical fiber 120 of the second plurality of optical fibers 118 within the optical fiber connector. In this manner, laser energy from each of the laser energy sources 102 is delivered to the optics assembly 104 such that laser energy 108 can be directed onto the build surface 110 during an additive manufacturing process (i.e., a build process). Of course, other methods of connecting the laser energy sources 102 due to the optics assembly 104 are also contemplated.

The additive manufacturing system further includes a controller 130 including at least one processor 140 and non-transitory computer readable memory 141. The controller may direct aspects of the additive manufacturing system including the laser energy sources. The additive manufacturing system may further include camera 150 which may provide a signal to the controller. The controller may interpret such signal to determine a measure of weld quality.

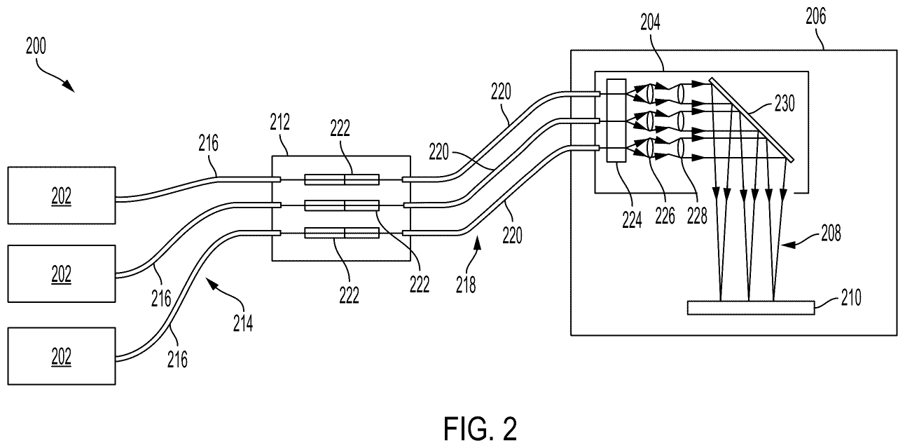

FIG. 2 shows a schematic representation of another embodiment of an additive manufacturing system 200. Similar to the embodiment discussed above in connection with FIG. 1, the additive manufacturing system 200 includes a plurality of laser energy sources 202 coupled to the optics assembly 204 within the machine enclosure 206 via the optical fiber connector 212. The first plurality of optical fibers 214 extends between the laser energy sources 202 and the optical fiber connector 212, and the second plurality of optical fibers 218 extends between the optical fiber connector 212 and optics assembly 204. In particular, each optical fiber 216 of the first plurality of optical fibers is coupled to a laser energy source 202 and corresponding optical fiber 220 of the second plurality of optical fibers 218. In the depicted embodiment, optical fibers 216 are coupled to corresponding optical fibers 220 via fusion splices 222 within the optical fiber connector 212. However, embodiments, in which the optical fibers positioned within the connector are optically coupled using other types of connections and/or single continuous optical fibers are used are also envisioned.

In the depicted embodiment, the optical fibers 220 of the second plurality of optical fibers 218 are optically coupled to an optics assembly 204 of the system. For example, an alignment fixture 224 is configured to define a desired spatial distribution of the optical fibers used to direct laser energy into the optics assembly. For example, the alignment fixture may comprise a block having a plurality of v-grooves or holes in which the optical fibers may be positioned and coupled to in order to accurately position the optical fibers within the system. In some embodiments, the disclosed optical paths may include fibers of different sizes and an adiabatic fiber taper. For example, a small upstream optical fiber and a larger downstream optical fiber with an adiabatic taper disposed there between may be used in place of the optical fibers 220. However, embodiments in which optical fibers of different sizes and adiabatic fiber taper are included in other portions of the optical path, such as in optical fibers 216, are also contemplated as the disclosure is not so limited.

FIG. 2 also depicts exemplary optics that are optically coupled to and positioned downstream from the second plurality of optical fibers 218. The various optics included in the optics assembly may be configured to direct laser energy 208 from the second plurality of optical fibers 218 on the build surface 210 to form a desired array pattern of laser energy pixels on the build surface. For example, the optics assembly may include beam forming optics such as lenses 226 and 228 (which may be individual lenses, lens arrays, and/or combined macrolenses), mirrors 230, and/or any other appropriate type of optics disposed along the various optical paths between the optical fibers and the build surface 210 which may shape and direct the laser energy within the optics assembly. Once appropriately sized and shaped, the laser energy 208 may be directed onto the build surface 210 either through direct transmission and/or using a light directing element such as the depicted mirror 230.

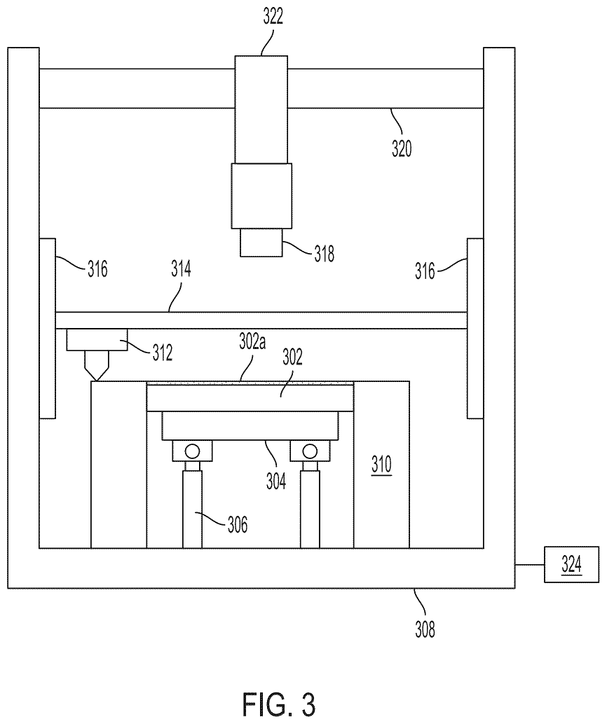

FIG. 3 depicts one embodiment of an additive manufacturing system at the beginning of a build process. The additive manufacturing system includes a build plate 302 mounted on a fixed plate 304, which is in turn mounted on one or more vertical supports 306 that attach to a base 308 of the additive manufacturing system. In the depicted embodiment, the one or more vertical supports may correspond to one, two, and/or any other appropriate number of supports configured to support the build plate, and the corresponding build surface, at a desired position and orientation. For example, the supports depicted in the figure may correspond to one or more vertical motion stages configured to control a vertical position and orientation of the build plate. A powder containment shroud 310 may at least partially, and in some embodiments completely, surround a perimeter of the build plate 302 to support a volume of precursor material 302a, such as a volume of powder, disposed on the build plate and contained within the shroud. The shroud may be supported on the base 308 or by any other appropriate portion of the system.

The additive manufacturing system may include a powder deposition system in the form of a recoater 312 that is mounted on a horizontal motion stage 314 that allows the recoater to be moved back and forth across either a portion, or entire, surface of the build plate 302. As the recoater traversers the build surface of the build plate, it deposits a precursor material 302a, such as a powder, onto the build plate and smooths the surface to provide a layer of precursor material with a predetermined thickness on top of the underlying volume of fused and/or unfused precursor material deposited during prior formation steps.

In some embodiments, the supports 306 of the build plate 302 may be used to index the build surface of the build plate 302 in a vertical downwards direction relative to a local direction of gravity. In such an embodiment, the recoater 312 may be held vertically stationary for dispensing precursor material 302a, such as a precursor powder, onto the exposed build surface of the build plate as the recoater is moved across the build plate each time the build plate is indexed downwards.

In some embodiments, the additive manufacturing system may also include an optics assembly 318 that is supported vertically above and oriented towards the build plate 302. As detailed above, the optics assembly may be optically coupled to one or more laser energy sources, not depicted, to direct laser energy in the form or one or more laser energy pixels onto the build surface of the build plate 302. To facilitate movement of the laser energy pixels across the build surface, the optics assembly may be configured to move in one, two, or any number of directions in a plane parallel to the build surface of the build plate. To provide this functionality, the optics assembly may be mounted on a gantry 320, or other actuated structure, that allows the optics unit to be scanned in plane parallel to the build surface of the build plate.

In the above embodiment, the build plate is indexed vertically while the remaining active portions of the system are held vertically stationary. However, embodiments, in which the build plate is held vertically stationary and the shroud 310, recoater 312, and optics assembly 318 are indexed vertically upwards relative to a local direction of gravity during formation of successive layers are also contemplated. In such an embodiment, the recoater horizontal motion stage 314 may be supported by vertical motion stages 316 that are configured to provide vertical movement of the recoater relative to the build plate. Corresponding vertical motion stages may also be provided for the shroud 310, not depicted, to index the shroud vertically upward relative to the build plate in such an embodiment. In some embodiments, the additive manufacturing system may also include an optics assembly 318 that is supported on a vertical motion stage 320 that is in turn mounted on the gantry 320 that allows the optics unit to be scanned in the plane of the build plate 302.

In the above embodiment, the vertical motion stages, horizontal motion stages, and gantry may correspond to any appropriate type of system that is configured to provide the desired vertical and/or horizontal motion. This may include supporting structures such as: rails; linear bearings, wheels, threaded shafts, and/or any other appropriate structure capable of supporting the various components during the desired movement. Movement of the components may also be provided using any appropriate type of actuator including, but not limited to, electric motors, stepper motors, hydraulic actuators, pneumatic actuators, electric actuators, and/or any other appropriate type of actuator as the disclosure is not so limited.

In addition to the above, in some embodiments, the depicted additive manufacturing system may include one or more controllers 324 that is operatively coupled to the various actively controlled components of the additive manufacturing system. For example, the one or more controllers may be operatively coupled to the one or more supports 306, recoater 312, optics assembly 318, the various motion stages, and/or any other appropriate component of the system. In some embodiments, the controller may include one or more processors and associated non-transitory computer readable memory. The non-transitory computer readable memory may include processor executable instructions that when executed by the one or more processors cause the additive manufacturing system to perform any of the methods disclosed herein.

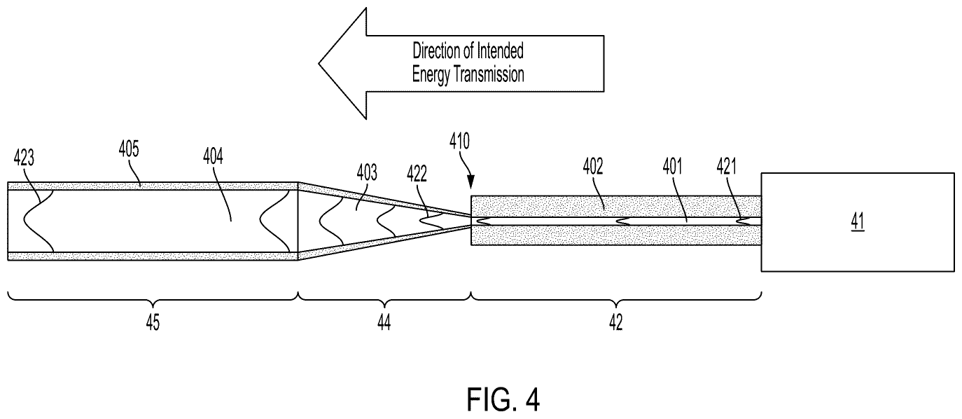

FIG. 4 shows a schematic of an optical path for the transmission of laser energy according to one embodiment. In the depicted embodiment, a laser energy source 41 is optically coupled to small optical fiber 42, adiabatic fiber taper 44 and large optical fiber 45.

The small optical fiber 42 includes a fiber core 401 and a cladding 402. Cladding surrounds the fiber core along the longitudinal surface of the fiber. The small optical fiber may be configured to carry a lowest mode laser energy, LP01 as represented by wave 421 traveling in the longitudinal direction along fiber 401 in a direction of intended energy transmission away from laser energy source 41. Laser energy is emitted from a laser energy source 41 into the small optical fiber 42. It should be noted that the length of small optical fiber 42 may be more than tens, hundreds, or thousands of times longer than either adiabatic fiber taper 44 or large optical fiber 45 in some embodiments. Small fiber 42 is illustrated as including a short length for representative purposes only, no limitation on length should be concluded from the figure.

Regarding its optical function, adiabatic fiber tapers may include one or more tapered surfaces to assist in the redirection of light within an optical path. The tapered surface may be tapered relative to the longitudinal axis of the optical fibers (and similarly, the optical pathway of the laser energy), such that light may be directed from an upstream small optical fiber core into another downstream larger optical fiber core or light aperture so as to limit the distortion of laser energy away from the lowest order mode and to reduce the energy reflected back to the laser energy source. The tapered surface may include an angled surface with a constant slope relative to the longitudinal direction, and/or may include any suitable geometry of the tapered surface, including curved, exponential, convex, concave, stepped, monotonically decreasing, non-monotonically decreasing, and/or any other suitable geometry. It should be appreciated that any combination of materials and geometry may be used to construct the taper or otherwise redirect laser energy from the optical fibers. For example, the taper may include a graded or stepped index material. Accordingly, the present disclosure is not limited by the geometry or material composition (including coatings) of any portion of the optical fiber or cladding mode stripper that may be used thereon.

In the various embodiments disclosed herein an adiabatic fiber taper may maintain a certain percentage of laser energy in the fundamental core mode (for instance in the lowest order mode, LP01). Without wishing to be bound by theory, the steeper the taper the larger the percentage of laser energy that is lost to higher order modes (such as LP11) or to the fiber cladding. At the limit of an abrupt change, a step change in fiber core transverse dimension, may result in a predictable loss from a mode field diameter (MFD) mismatch between two single mode fibers. A fiber taper reduces the loss that would otherwise result from such an abrupt change. The longer the taper, the less energy may be lost such as to higher order modes and the more adiabatic the taper. According to some embodiments, an adiabatic fiber taper may be a fiber taper that maintains greater than or equal to 90% of the incoming laser energy in the fundamental core mode (such as LP01) at the downstream end portion of the taper. Adiabatic tapers may also maintain greater than or equal to 90%, 95%, 97.5%, 99%, and/or any other appropriate percentage of laser energy in the fundamental core mode, or other characterization of a lowest order mode of light being transmitted through the optical fibers, during transmission through the adiabatic fiber taper. In some embodiments, the fundamental core mode may be a lowest order LP01 mode. According to some embodiments, an adiabatic fiber taper between a small fiber (such as a single mode small fiber) and a large fiber may have a rate of change along the length of the adiabatic taper such that the transverse dimension (such as diameter) of the taper may double over a longitudinal distance of 10 mm or greater along a length of the adiabatic fiber taper. According to some embodiments the rate of taper may be such that the transverse dimension of the fiber core doubles every 10 mm, 15 mm, 20 mm, or other appropriate length of longitudinal travel along a length of a fiber. Combinations of the above are contemplated including a rate of change of the adiabatic fiber taper where the transverse dimension may double over a length that is between or equal to 10 mm and 20 mm. Of course, other ranges of the above parameters including ranges both greater and less than those disclosed above may be used as the disclosure is not so limited. Additionally, it should be understood that this type of adiabatic taper may be used with any of the embodiments disclosed herein.

An adiabatic fiber taper 44 may be optically coupled to the small optical fiber 42 at splice 410. The adiabatic fiber taper may be disposed on, or optionally formed in, the upstream portion of the large optical fiber such that the core 403 of taper 44 and core 404 of the large core fiber 45 may be optically coupled with one another. Thus, in some embodiments, the adiabatic fiber taper and the core of the large optical fiber may be formed as a unitary piece as illustrated, though the formation and connection of a separate adiabatic fiber taper is also contemplated. Again, the transverse dimension of the large optical fiber may be larger than the transverse dimension of the small optical fiber. Correspondingly, the transverse dimension of the upstream end portion of adiabatic fiber taper 44 is smaller than the transverse dimension of the downstream end portion of the adiabatic fiber taper. Transverse dimensions within the small and large optical fibers away from the adiabatic fiber taper may be substantially constant in some embodiments.

During operation, the emitted laser energy may be expanded in the adiabatic fiber taper from the small optical fiber to the large optical fiber, wherein a transverse dimension of the small optical fiber is less than a transverse dimension of the large optical fiber. Laser energy may enter the adiabatic fiber taper 44 at splice 410 as single mode laser energy and passes through the taper as substantial single mode as illustrated by the waveform 422 remaining as such in the large optical fiber, waveform 423. Antireflective coatings or other surface coatings may be applied to any portion of the optical fiber including the upstream and downstream portions. Cladding 405 and 402 may also surround the large optical fiber and/or small optical fiber respectively. The cladding may be configured to capture higher mode laser energy.

The direction of the primary light travel illustrated by the arrow is from the laser energy source 41 towards the distal end of large optical fiber 45. The large optical fiber may be optically coupled to the optics head at the distal end of large optical fiber 45. Laser energy may be directed from the large optical fiber onto a build surface of an additive manufacturing system as described previously above. The end portion nearest to the laser energy source is termed the upstream end portion and the end portion distal to the laser energy source is the downstream end portion. Upstream and downstream are in reference to the direction of primary, intended energy transmission. The direction of primary energy transmission through the constant dimension portions of the fiber is the longitudinal direction, that is along the length of the fiber. The direction orthogonal to the longitudinal direction is the transverse direction. The core dimension of the fiber may therefore be referred to as the transverse dimension. For instance, if a fiber is of circular cross section, then the transverse dimension of that fiber is the diameter of that fiber. Non-circular fibers are also contemplated.

The embodiments previously described include an adiabatic fiber taper within the fiber path such that the fiber core transverse dimension may increase in the primary direction of light travel. Other embodiments are contemplated with multiple optical paths including a down taper such as a taper where the transverse dimension of the optical fiber path may decrease in the primary direction of light travel. According to one embodiment, single mode delivery fiber, the small optical fiber, that is the constant transverse dimension fiber from the laser energy source to a location near the optics head, may terminate with a down taper at an end distal to the laser energy source and abutting the adiabatic fiber taper coupled to a large optical fiber. According to this embodiment, the fiber splice may occur between the decreasing transverse dimension taper and the adiabatic fiber taper with an increasing transverse dimension in the downstream direction, such that the splice may be located at the smallest transverse cross-section along the length of the optical fiber path. The largest transverse dimension of the down taper may be the transverse dimension of the small optical fiber. The down taper may be any suitable taper or splice of optical fibers. However, in other embodiments, the down taper may be an adiabatic fiber taper as this disclosure is not to be so limiting. In some embodiments, the down taper may only support lowest order modes (LP01) thereby causing higher order modes in the delivery fiber to be transferred to the cladding to improve core beam quality. As described further below, reflected laser energy and other light traveling upstream opposite to the direction of the laser energy direction is usually multi-mode. Accordingly, the fiber down taper may be configured to not support higher order modes which may facilitate transmission of this multi-mode light into the cladding. Cladding laser energy may then be removed by cladding mode strippers.

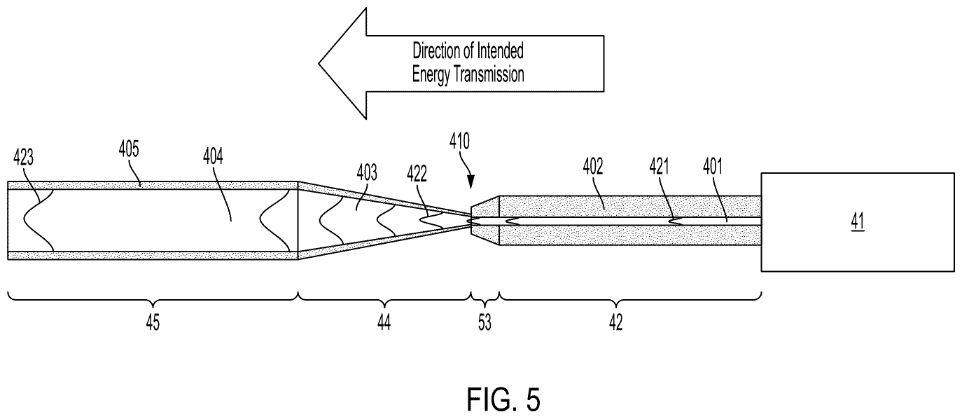

FIG. 5 shows a schematic of an optical path for laser energy according to one embodiment including a down taper upstream from and optically connected to the adiabatic fiber taper. In some embodiments, the down taper is directly coupled to the adiabatic taper. The down taper 53 is provided to compress the laser energy to remove higher order modes of laser energy from the optical path for the purpose of improving the beam quality of the laser energy. Higher order laser energy removed at the down taper may be traveling in the upstream or the downstream direction. As in the embodiment of FIG. 4, a laser energy source 41 may be optically coupled to emit laser energy into a small optical fiber 42. An adiabatic fiber taper 44 may expand the emitted laser energy with a transverse dimension increasing in the downstream direction. A large optical fiber 45 is located distal to the adiabatic taper and optically coupled thereto. The direction of the primary light travel illustrated by the arrow is from the laser energy source 41 to the distal end of large optical fiber 45.

As depicted in FIG. 5, a down taper 53 is disposed between the small core optical fiber 42 and the adiabatic fiber taper 44. The down taper 53 optically couples the small optical fiber 42 and the adiabatic taper 44, such that the upstream transverse dimension of the adiabatic taper is less than the transverse dimension of the small optical fiber. The splice 410 occurs at the smallest transverse dimension region formed by the connection of the down taper and the up taper. The transverse dimension of the small optical fiber remains less than the transverse dimension of the large optical fiber. The transverse dimension of the down taper decreases in the downstream direction from the transverse dimension of the core of the small optical fiber to the upstream end of the adiabatic taper. The transverse dimension of the down taper remains smaller than the transverse dimension of the large optical fiber. The relative sizing of the transverse dimensions is applied to the fiber core although the same relative sizing holds for the cladding as well.

Depending on the desired application, a down taper may exhibit any appropriate combination of dimensions. For example, a down taper may exhibit a rate of taper which may double a transverse dimension of the fiber core every 10 mm, 15 mm, 20 mm, or other appropriate length relative to longitudinal travel along a length of the down taper. Of course, down tapers with ranges of dimensions that are both greater than and less than those noted above are also contemplated as the disclosure is not so limited. According to some embodiments, the down taper may maintain greater than or equal to 90%, 95%, 97.5%, 99%, or other appropriate percentage of laser energy in the fundamental core mode, which may be the LP01 mode in some embodiments. In some embodiments, the down taper may be an adiabatic down taper. Additionally, ranges different than those noted above, including ranges both greater and less than those noted above, may be used as the disclosure is not so limited.

During operation, laser energy is transmitted from the laser energy source 41 through the small optical fiber 42 as lowest order mode energy and into the down taper 53. The laser energy is then transmitted from the down taper into the expanding adiabatic fiber taper 44. Energy from down taper 53 enters the adiabatic fiber taper at splice 410 as single mode laser energy. The laser energy may then expand through the adiabatic fiber taper as substantially single mode laser energy in some embodiments as previously described above and as illustrated by the waveform 422 prior to propagating through the large optical fiber as waveform 423. Laser energy may then be emitted onto the build surface substantially as single mode, lowest order mode laser energy. It should be appreciated that a single splice is illustrated in the depicted embodiment, however additional splices are possible.

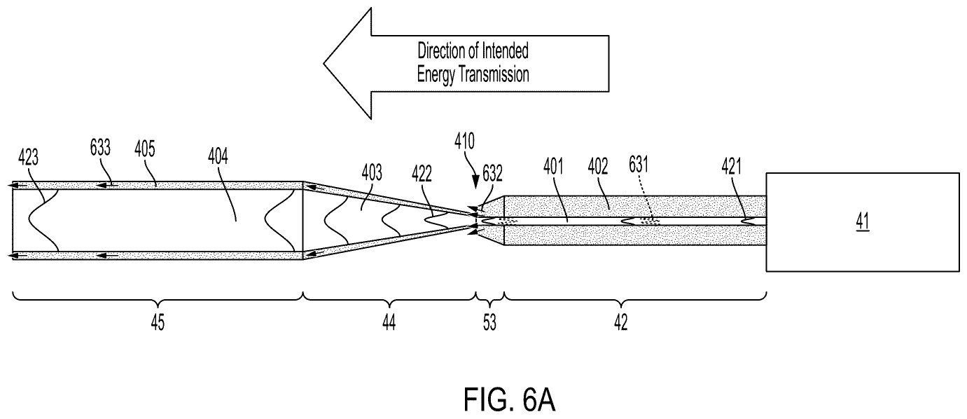

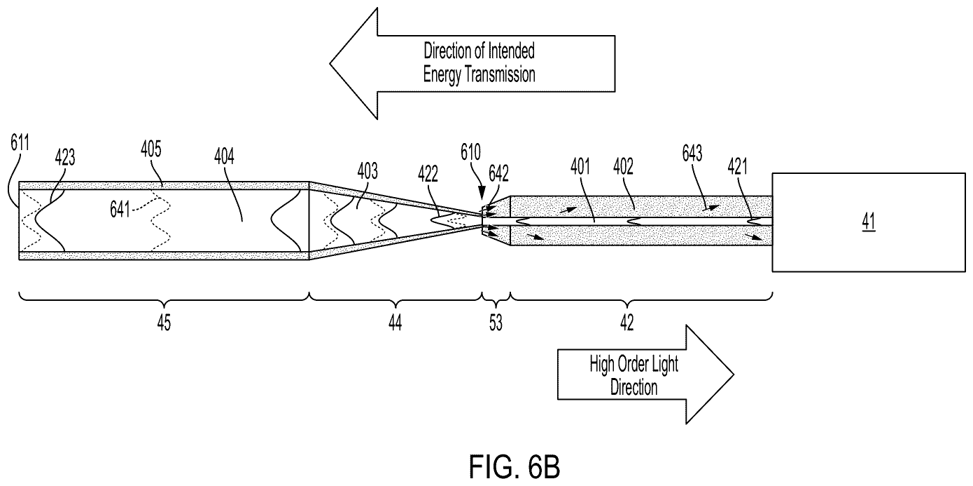

FIG. 6A illustrates light propagation through an optical path as illustrated in FIG. 5. Component numbering follows the same convention as FIG. 5. It will be observed that single lowest order mode laser energy 421 follows small optical fiber 401. At splice 410, some energy may be reflected back toward the upstream end. The back reflected energy may be generally higher mode laser energy as seen by waveform 631. The reflected energy of waveform 631 may be less intense than the transmitted energy 421 so that the direction of primary energy transmission remains in the downstream in the longitudinal direction along fiber core 401. Also at splice 410, some laser energy 632 may be scattered such that it enters the cladding 405 as illustrated by 633. Energy that enters the cladding or is reflected back in the small optical fiber may be wasted from the process and does not provide useful benefit. FIG. 6A therefore illustrates forward losses in the large diameter cladding and back reflection in the small core fiber.

FIG. 6B illustrates light propagation through an optical path as illustrated in FIGS. 5 and 6A including back light travel in the small optical fiber cladding and back reflection in the large optical fiber core. Again, component nomenclature is as in FIGS. 5 and 6A. Light travels through large optical fiber 404 encountering the downstream termination 611. At the downstream termination 611 some light may be back reflected by the change in propagation media. The back reflected waveform 641 propagates upstream along the large optical fiber, typically as higher order mode energy. The back reflected energy may enter adiabatic fiber taper 44 propagating counter to the primary or intended direction of energy transmission. The waveform is compressed by the taper and scattered into the small optical fiber cladding 642 at splice 410 corresponding with the point of minimum transverse dimension of down taper 53. Light may then propagate upstream in the small cladding 402 as shown by 643. The backward propagation of the higher order light is illustrated by the high order light direction arrow. It should be appreciated that the backward directed light may be a small portion of the total laser energy so the net direction of energy transmission remains the direction of intended energy transmission as indicated. It should also be appreciated that the reflected and cladding energy of FIGS. 6A and 6B are illustrated separately only for purposes of clarity and the transmission occurs according to both figures simultaneously.

Cladding mode strippers may be disposed along at least a portion of the length of the cladding of an optical fiber to remove laser energy that has entered the cladding and is therefore not useful to the process. Removing laser energy from the cladding may reduce heating of the fiber and enhance fiber life and/or reliability. Cladding mode strippers may be of any material and/or construction that is an absorber of light with a higher refractive index than the optical path and may be located on the cladding anywhere along the optical path. In some embodiments cladding mode strippers may be high index epoxy. In some embodiments, cladding mode strippers may be a textured portion of the optical fiber such as by etching a suitable material including glass. In some cases, strippers may be formed by ablating and annealing a glass surface with lasers and potting in a low index material. In some embodiments, it may be desirable to vary the stripping strength of the cladding mode stripper with increasing strength in the travel direction of the light that is to be removed. For instance, if a stripper is of uniform strength, it will remove a greater proportion of cladding laser energy near the “inlet” or upstream side of the stripper. This may result in greater local heating in that portion of the stripper than in a downstream portion of the stripper that removes a smaller quantity of energy from the cladding. If the strength of the stripper increases in the primary direction of propagation of the light along the fiber, the proportion of light removal or light energy removed per unit length (or area) of the stripper may be made more uniform. This may result in more uniform temperature within the cladding mode stripper and may avoid hot spots therein. The result may be increased life and/or reliability. Cladding mode strippers may also be actively cooled. For example, active cooling may include cooling by convection with a moving fluid.

Depending on the embodiment, cladding mode strippers may remove greater than or equal to 50% of cladding laser energy, greater than or equal to 90% of cladding laser energy, greater than or equal to 99% of cladding laser energy, and/or any other appropriate percentage. Combinations between or equal to the above ranges are also contemplated. For example, a stripper may be configured to remove between or equal to 50 and 99% of cladding laser energy. Of course, other ranges both greater than and less than those noted above are also contemplated as the disclosure is not so limited.

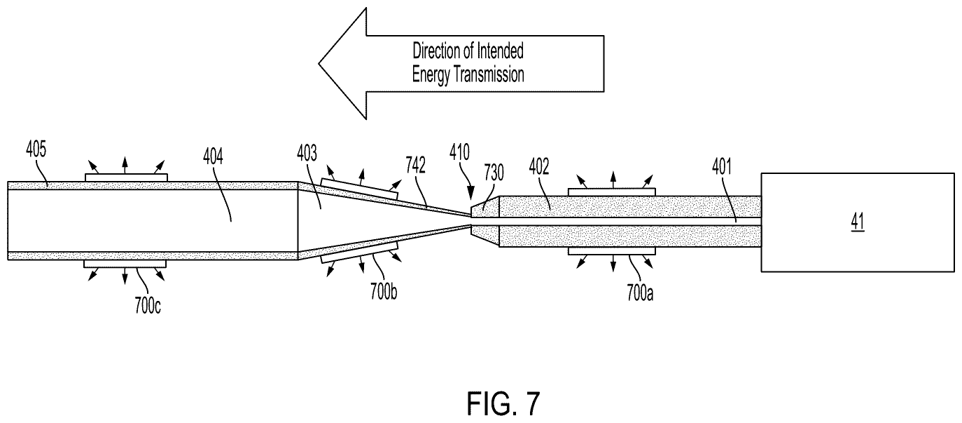

FIG. 7 illustrates an optical path similar to that of FIG. 5 with the inclusion of cladding mode strippers. Laser energy source 41 is optically coupled to small optical fiber 401 with small core fiber cladding 402. Adiabatic fiber taper core 403 is optically coupled to the down taper 730 which is connected to a downstream portion of the small optical fiber at splice 410. Large fiber 404 likewise includes cladding 705. Three cladding mode strippers are illustrated, cladding stripper 700a on the small cladding 402, cladding stripper 700b on taper cladding 742 and stripper 700c on large optical fiber cladding 405. For clarity, light propagation, waveforms, and cladding light are not illustrated in FIG. 7. It should be appreciated that the three cladding mode strippers illustrated may be used together or separately and may be located in positions along the fiber cladding different from those illustrated. Cladding mode strippers may be of the same type or of different types and may have a stripping intensity that varies with longitudinal position along a length of the fiber. Additional cladding mode strippers may be used as this disclosure is not limited in the number, location, or type of cladding mode strippers.

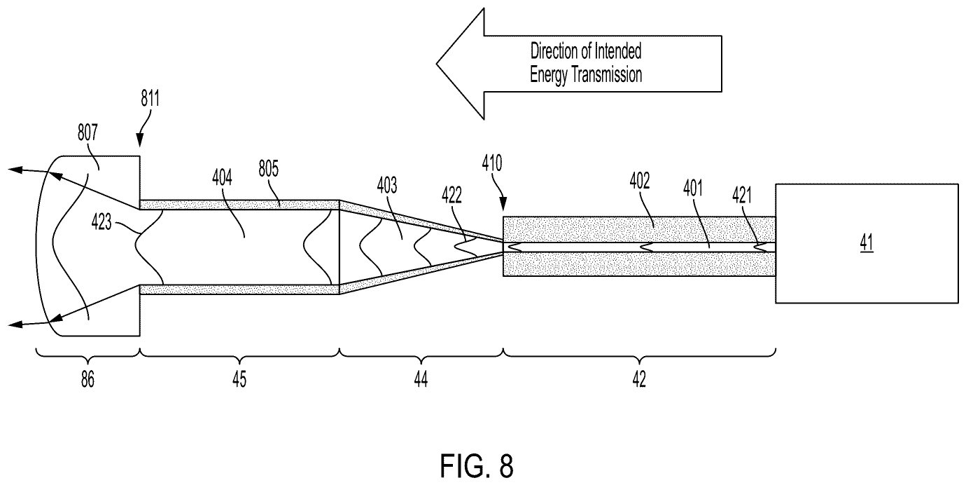

FIG. 8 illustrates an optical path of FIG. 4 including an endcap 807 on the downstream end of the optical fiber. An endcap may further focus and/or expand the laser energy to reduce the areal power/energy density at the termination of the optical path. Endcap 86 is located on and optically coupled to the downstream end portion of large optical fiber 45. The endcap and large optical fiber are optically coupled at junction 811. As illustrated the optic 807 forming endcap 86 is a lensed endcap. A lensed endcap may expand, focus, and/or redirect the beam as illustrated. In the case of a lensed endcap, a downstream face of the endcap may not be parallel with an up stream face of the endcap 811, such that the thickness of the endcap varies along its face. The thickness may vary to form a concave or convex face of the lens. A lens endcap may include a material with a different refractive index than the optical fiber in some embodiments, though embodiments in which matched refractive indices are used are also contemplated. The endcap may include two or more materials which may have different refractive indices from each other, such as a doublet lens, in some embodiments. Lensed endcaps having components with more than one refractive index may have parallel upstream and downstream faces. Flat (non-lensed) endcaps are also contemplated. Endcaps located on the end portion of the large optical fiber may further reduce intensity as the air interface and may lead to additional improvement in yield, lifetime, and/or contamination resistance of the optical fiber path. In some embodiments, an optical fiber with a transvers dimension that is larger than a transverse dimension of the large optical fiber may be used as an endcap. Antireflective coatings may be applied to the endcap or downstream termination of the very large optical fiber. As will be apparent from FIG. 8, the larger transverse dimension of endcap 86 may reduce the power/energy density at the air interface; may reduce localized heating; and may extend the lifetime of the termination.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. An additive manufacturing system, comprising:
a laser energy source;
an optics assembly configured to direct laser energy from the laser energy source to form a laser energy pixel on a build surface;
a first optical fiber optically coupled to the laser energy source;
a second optical fiber optically coupled to the optics assembly, wherein a transverse dimension of the first optical fiber is less than a transverse dimension of the second optical fiber; and
an adiabatic fiber taper optically coupling the first optical fiber to the second optical fiber, wherein the adiabatic fiber taper includes an upstream end portion optically coupled to the first optical fiber and a downstream end portion optically coupled to the second optical fiber, and wherein a transverse dimension of the upstream end portion is less than a transverse dimension of the downstream end portion.

2. The additive manufacturing system of claim 1, wherein the first optical fiber is configured to transmit single mode laser energy.

3. The additive manufacturing system of claim 1, wherein the adiabatic fiber taper is configured to maintain laser energy in a lowest order mode at the second end portion.

4. The additive manufacturing system of claim 1, wherein the second optical fiber is configured to convey lowest order mode laser energy from the second end portion of the adiabatic fiber taper to the optics assembly.

5. The additive manufacturing system of claim 1, further comprising a second fiber taper optically coupling the first optical fiber to the adiabatic fiber taper, wherein the second fiber taper includes a second upstream end portion optically coupled to the first optical fiber and a second downstream end portion optically coupled to the adiabatic fiber taper, and wherein a transverse dimension of the second upstream end portion is greater than a transverse dimension of the second downstream end portion.

6. The additive manufacturing system of claim 1, wherein the additive manufacturing system additionally comprises an endcap optically coupled to a downstream end portion of the second optical fiber.

7. The additive manufacturing system of claim 6, wherein the endcap comprises a lens.

8. The additive manufacturing system of claim 1, wherein the second fiber has a second fiber length, and wherein a ratio of the second fiber length to the transverse dimension of the second fiber is less than 10,000.

9. The additive manufacturing system of claim 1, wherein the additive manufacturing system additionally comprises at least one cladding mode stripper, the at least one cladding mode stripper disposed on at least one selected from the first optical fiber, the second optical fiber and the adiabatic fiber taper.

10. The additive manufacturing system of claim 9, wherein the cladding mode stripper is configured to remove at least 50 percent of laser energy present in cladding at a location of the cladding mode stripper.

11. The additive manufacturing system of claim 1, wherein the first optical fiber is a photonic crystal optical fiber.

12. The additive manufacturing system of claim 1, wherein the first optical fiber includes a first core and wherein the first core has a transverse dimension between or equal to 10 μm and 25 μm.

13. The additive manufacturing system of claim 1, wherein the second optical fiber includes a second core and wherein the second core has a transverse dimension between or equal to 100 μm and 500 μm.

14. The additive manufacturing system of claim 1, wherein at least one of the first optical fiber and the second optical fiber are configured transmit laser energy with powers between or equal to 0.1 W/μm² and 3 W/μm².

15. An additive manufacturing method, the method comprising:
emitting laser energy from a laser energy source into a first optical fiber;
expanding the emitted laser energy in an adiabatic fiber taper from the first optical fiber to a second optical fiber, wherein a transverse dimension of the first optical fiber is less than a transverse dimension of the second optical fiber; and
directing the laser energy from the second optical fiber onto a build surface of an additive manufacturing system.

16. The method of claim 15, further including transmitting laser energy within the first optical fiber as lowest order mode laser energy.

17. The method of claim 15, further comprising:
transmitting laser energy through at least the first optical fiber, the second optical fiber, and the adiabatic fiber taper;
transmitting at least a portion of the laser energy into cladding; and
stripping laser energy transmitted through the cladding with a cladding mode stripper.

18. The method of claim 17, wherein the cladding mode stripper removes at least 50 percent of the portion of laser energy carried by the cladding at the location of the cladding mode stripper.

19. The method of claim 17, wherein the cladding mode stripper removes at least 90 percent of the portion of laser energy carried by the cladding at the location of the cladding mode stripper.

20. The method of claim 17, wherein the cladding is associated with at least one selected from the first optical fiber, the second optical fiber, and the adiabatic fiber taper.

21. The method of claim 15, further including compressing the emitted laser energy at a location upstream of the adiabatic fiber taper.

22. The method of claim 15, further comprising transmitting single mode laser energy through the first optical fiber.

23. The method of claim 15, wherein expanding the emitted laser energy in the adiabatic fiber taper includes expanding the emitted laser energy while maintain laser energy in a lowest order mode at the second optical fiber.

24. The method of claim 15, wherein the laser energy is transmitted in the second optical fiber as lowest order mode laser energy from the adiabatic fiber taper to a downstream optics assembly.

25. The method of claim 15, further comprising expanding the laser energy in an endcap optically coupled to the downstream end portion of the second optical fiber.

26. The method of claim 15, wherein emitting laser energy into the first optical fiber includes emitting laser energy into a photonic crystal optical fiber.

27. The method of claim 15, wherein the first optical fiber includes a first core, and wherein the first core has a transverse dimension between 10 μm and 25 μm.

28. The method of claim 15, wherein the second optical fiber includes a second core, and wherein the second core has a transverse dimension between 100 μm and 500 μm.

29. The method of claim 15, further comprising transmitting laser energy in at least one of the first optical fiber and the second optical fiber within a range between or equal to 0.1 W/μm² and 3 W/μm².

30. The method of claim 15, further comprising fusing precursor material with the laser energy to form one or more parts on the build surface.

31. A part manufactured using the method of claim 15.
